(19) United States
(12) Patent Application Publication
(10) Pub. No.: US 2015/0120542 A1
(43) Pub. Date: Apr. 30, 2015

(54) SYSTEM AND METHOD FOR OVERRIDING RULE DRIVEN AUTOMATED DECISIONS

(71) Applicant: NCR Corporation, Duluth, GA (US)

(72) Inventors: John Scott Byers, Perthshire (GB); Finona McDade, Dundee (GB)

(73) Assignee: NCR Corporation, Duluth, GA (US)

(21) Appl. No.: 14/066,217

(22) Filed: Oct. 29, 2013

(51) Int. Cl. G06Q 20/40; G06Q 20/10

(52) U.S. Cl. CPC G06Q 20/40; G06Q 20/1085
USPC 705/43; 705/44

(57) ABSTRACT

A system and method for overriding rule-driven automated decisions that result from the use of an automated consumer device associated with rule-driven automated systems. In an aspect, the automated rules-driven override system comprises an automated consumer device, an interactive server, core decision systems, and an override device. In an aspect, the automated consumer device, the interactive server and the override device are configured to work in concert with one another to override certain decisions performed by the core decision systems.

### BACKGROUND OF THE INVENTION

1. Technical Field

The present invention is in the technical field of automated rule-driven decision systems. In one embodiment, the present invention is in the technical field of automated rule-driven host financial systems used in the authorization of customer transactions.

2. Related Art

Many institutions utilize automated systems to perform requested tasks from customers. For example, banks have utilized automated teller machines (ATM) to allow customers to deposit and withdraw money from accounts for years without the need or assistance of bank personnel. These automated systems traditionally apply some rule-based authorization systems to assist in the approval of certain transactions with customers of the institutions. For example, automated systems can be found in authorization needed services, such as check deposit clearing systems, mortgage and loan approvals, credit card applications, airline check-in kiosks, and the like.

In the check deposit clearing systems example, banking and financial institutions have relied on rule-based automated systems when determining when to provide funds to a customer who has deposited a check with the institution. In this example, a customer may deposit a check at an ATM or similar automated device. The ATM will pass along information related to the checks being deposited, as well as information about the customer, to a transaction host system. The transaction host system will then make the determination as to if and when the deposited checks will be cleared, and the corresponding funds made available to the customer. The transaction host system will make the determinations based upon the rules of the financial institution as well as the attributes of the customer. In such situations, the funds can be made immediately available to the customer, available after a certain hold period (which can be a standard period or extended period based upon the determination of the system), or the funds can be denied. The determination, or decision, is then conveyed to the customer.

While these systems provide the institutions with protection against potential fraud from customers, these systems make determinations based upon limited amounts of information and strict rules that cannot be deviated from unless additional support is given. For example, referring to the check deposit system, the automated system may be limited to information related to only checking accounts of the customer, even though the customer has numerous other accounts with the institution (e.g., investment and brokerage accounts, and CDs and other assets secured with the institution). These limitations can lead to unsatisfied customers that demand different results based upon additional information that is not easily accessible to the automated system. In the check deposit example, a customer can be unsatisfied with the amount of holds and/or the length of such holds on the checks deposited, as determined by the automated system. These automated systems do not allow customers to provide the additional information in order to reach a different outcome, leaving customers dissatisfied with the institutions.

Further, automated systems that use some form of automated customer input devices (e.g., ATMs) do not provide a means for the customers to request for the override or modification of the just-performed transaction before final acceptance. For example, if a customer has deposited checks that the automated rules-based system has placed undesirable holds over, the customer has no means to request the return of these checks.

Therefore, there is a need for a system that allows additional information to be submitted to the automated system to facilitate the override of the decision for the automated system, based upon additional information that is not presently available to the automated system. Further, there is also a need for a system that allows customers to request and modify changes made to the transactions performed through the automated system.

### SUMMARY OF INVENTION

The present invention is a system and method for overriding rule-driven automated decisions that result from the use of an automated device (such as a consumer device) associated with rule-driven automated systems. In an aspect, the automated rules-driven override system comprises an automated consumer device, an interactive server, core decision systems, and an override device. In an aspect, the automated consumer device, the interactive server and the override device are configured to work in concert with one another to override certain decisions performed by the core decision systems.

In an aspect, the override device can be utilized by personnel of an institution associated with the automated consumer device. The override device can provide the personnel with all information relating to the automated consumer devices, the customers using the automated consumer devices, and the information about the customer transactions.

These and other objects and advantages of the invention will become apparent from the following detailed description of one embodiment of the invention.

Both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

FIG. 1 is a block diagram of an automated rules-driven override system according to an aspect.

FIG. 2 is a block diagram of an automated consumer device of FIG. 1 according to an aspect.

FIG. 3 is a block diagram of an interaction server of FIG. 1 according to an aspect.

FIG. 4 is a block diagram of an override device of FIG. 1 according to an aspect.

FIG. 5 is a block diagram of a core decision system of FIG. 1 according to an aspect.

FIG. 6 is a flow diagram of a method performed by the automated rules-driven override system according to an aspect.

FIG. 7 is a flow diagram of a method performed by an automated rules-override system according to an aspect.

FIG. 8 is a flow diagram of a method performed by the automated rules-override system of FIG. 7.

FIG. 9 is a flow diagram of a portion of the method of FIG. 8.

FIG. 10 is a flow diagram of a portion of the method of FIG. 8.

FIG. 11 is a flow diagram of a portion of the method of FIG. 8.

FIG. 12 is a flow diagram of a portion of the method of FIG. 8.

FIGS. 13-30 illustrate exemplary screen shots of an example of a method performed by an aspect of the automated rules-override system.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. To the extent necessary to understand or complete the disclosure of the present invention, all publications, patents, and patent applications mentioned herein are expressly incorporated by reference therein to the same extent as though each were individually so incorporated.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes [symbol] from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. In addition, the present methods and systems may be implemented by centrally located servers or cloud services. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, computers and components found in cloud services, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, cloud services, mobile devices (e.g., smart phones, tablets, and the like), automated teller machines, and multiprocessor systems. Additional examples comprise set top boxes, programmable consumer electronics, network PCs, minicomputers, mainframe computers, enterprise servers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

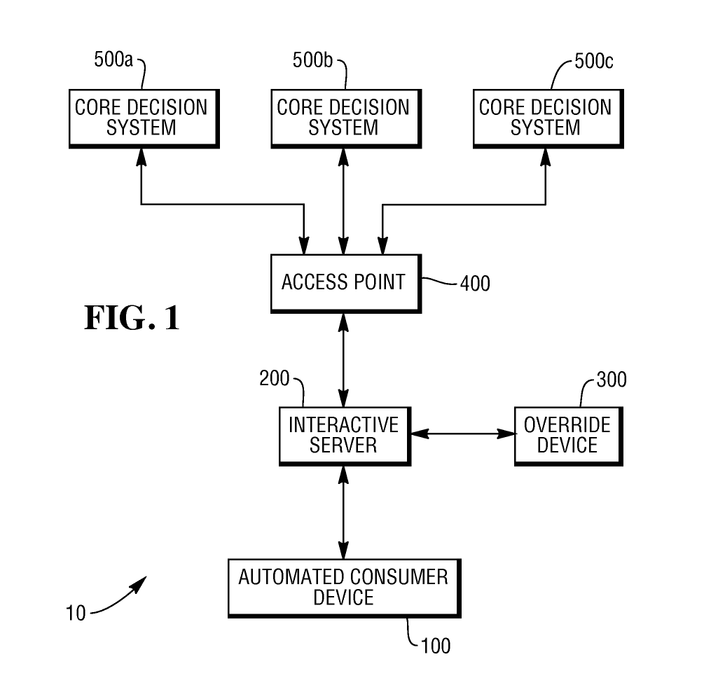

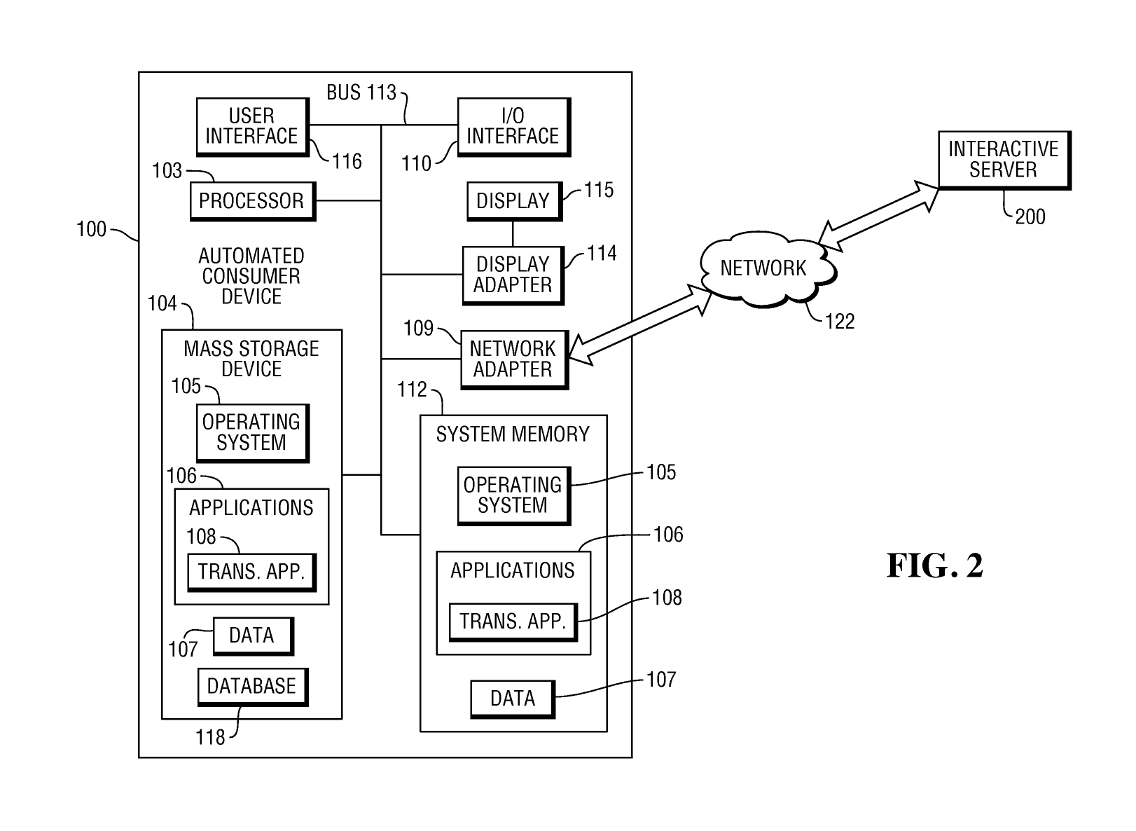

Referring to FIGS. 1 and 2, the present invention is directed to an automated rules-driven override system 10. According to an aspect, the automated rules-driven override system 10 comprises an automated consumer device 100, an interactive server 200, an override device 300, an access point 400, and core decision systems 500a,b,c. A consumer can use the automated consumer device 100 to request a specific transaction to be performed. The automated consumer device 100 transfers such request to the interactive server 200 which can call upon the access point 400 to transfer the request to the appropriate core decision system 500a,b,c for authorization (e.g., carry out the request or deny the request). The appropriate core decision system 500a,b,c sends the decision back to the automated consumer device 100 via the access point and interactive server 200. If the consumer at the automated consumer device 100 wishes to request modification of the decision, the automated consumer device 100, via the interactive server 200, can call upon the override device 300 for assistance. In an aspect, an administrator associated with the override device 300 can then assist the client at the automated consumer device 100 with the attempt to modify/override the decisions of the core decision systems 500a,b,c. While FIG. 1 illustrates only one automated consumer device 100, interactive server 200, override device 300, and access point 400, the automated rules-driven override system 10 can comprise a plurality of these components. Likewise, the number of core decision systems 500a,b,c can vary as well.

Referring to FIG. 2, the automated consumer device 100 may have several applications 106, including, but not limited to, transaction application 108. In an aspect, the automated consumer device 100 and its applications 106 may utilize elements and/or modules of several nodes or servers and the like. In any event, the automated consumer device 100 should be construed as inclusive of multiple modules, software applications, servers and other components that are separate from the interactive server 200, the override device 300, the access point 400, and the core decision systems 500a,b,c.

In an aspect, the automated consumer device 100 can comprise an automated teller machine (ATM) 100. However, the automated consumer device 100 is not limited to just ATMs. The automated consumer device 100 can include other devices that assist individuals in interacting with automated decision systems. For example, the automate consumer device can include, but is not limited to, point of sale self-service kiosks, airline check-in kiosks, personal computers associated with automate decisions systems, and the like.

In an aspect, the automated consumer device 100, in addition to the applications 106, including the transaction application 108, can comprise, but are not limited to, one or more processors or processing units 103, a system memory 112, and a system bus 113 that couples various system components including the processor 103 to the system memory 112. In the case of multiple processing units 103, the automated consumer device 100 can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, applications 106, including, but not limited to, the override application 108, a network adapter 109, system memory 112, an Input/Output Interface 110, a display adapter 114, a display device 115, and a user interface 116. As discussed above, these components can be contained within one or more computing devices at physically separate locations, connected through buses of this form, in effect implementing a fully distributed system, or can be contained in one device at one location.

The automated consumer device 100 can utilize a variety of computer readable media. Exemplary readable media can be any available media that is accessible by the automated consumer device 100 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as data 107 and/or program modules such as operating system 105 and override application 108 that are immediately accessible to and/or are presently operated on by the processing unit 103.

In another aspect, the automated consumer device 100 can also comprise other removable/non-removable, volatile/non-volatile computer storage media. By way of example, FIG. 2 illustrates a mass storage device 104 which can provide non-volatile storage of computer code, computer readable instructions, data structures, including databases 118, program modules, and other data needed for operations of the automated consumer device 100, as well as the automated rules-driven override system 10. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and various applications 106, including the transaction application 108. Each of the operating system 105 and other applications 106 (or some combination thereof) can comprise elements of the programming and the transaction application/software 108. Data 107 can also be stored on the mass storage device 104.

In another aspect, a consumer can enter commands and information into the automated consumer device 100 via an input device (not shown). Examples of such input devices comprise, but are not limited to, a keyboard, pointing device (e.g., a “mouse”), a microphone, a joystick, a scanner, tactile input devices such as gloves, and other body coverings, and the like. In an aspect, the input device can include an interactive touch screen and corresponding keypad, similar to those found in ATMs and self-service kiosks. Further examples can include image capturing devices, such as, but not limited to, optical coherence tomography capturing devices, fundus cameras, scanning laser ophthalmoscope, and other devices used to capture images and other information related to the monitoring and examination of eyes. These and other input devices can be connected to the processing unit 103 via a human machine interface 116 that is coupled to the system bus 113, but can be connected by other interface and bus structures, such as a parallel port, game port, an IEEE 1394 Port (also known as a Firewire port), a serial port, or a universal serial bus (USB), or network connection. While a variety of input devices can be used with the automated consumer device 100, the input devices must allow the individual to be able to carry out the desired transaction, as well as request assistance of the override device 300, discussed in more detail below.

In yet another aspect, a display device 115 can also be connected to the system bus 113 via an interface, such as a display adapter 114. It is contemplated that the automated consumer device 100 can have more than one display device 115. For example, a display device can be a monitor, an LCD (Liquid Crystal Display), an interactive touchscreen as discussed above, or a projector. In addition to the display device 115, other output peripheral devices can comprise components such as speakers (not shown) and a printer (not shown) which can be connected to the automated consumer device 100 via Input/Output Interface 110. Any step and/or result of the methods can be output in any form to an output device. This output can be any form of visual representation, including, but not limited to, textual, graphical, animation, audio, tactile, and the like. For example, when the automated consumer device 100 comprises an ATM, displays, video cameras, speakers, keyboards, and other input devices can be connected to the input/output interface 110.

The automated consumer device 100 is configured to communicate with the interactive server 200. Logical connections between the automated consumer device 100 and the interactive server 200 can be made over a network 122. These network connections can be through a network adapter 109. A network adapter 109 can be implemented in both wired and wireless environments. Such networks 122 can include enterprise-wide computer networks, intranets, private networks (e.g., legacy SNA networks, X25), IP networks, cellular networks, and the like.

Referring to FIGS. 1-3, the automated consumer device 100 communicates with the interactive server 200. In an aspect, the interactive server 200 is configured to manage the automated consumer devices 100 associated with the interactive server 200, process the requests from the automated consumer devices 100 (initiated by consumers), forward the requests to the core decision systems 500 (via the access point 400), send the decisions on the requests back to the automated consumer devices 100, and facilitate any requests for help or overrides from the automated consumer device 100. In an aspect, the interactive server 200 is configured to also retain and distribute information and rules associated with the requests and decisions, as discussed in more detail below. The interactive server 200 also is configured to communicate with the override device 300, discussed in more detail below. While FIGS. 1-3 refer to and display an interactive server 200, one skilled in the art will appreciate that the interactive server 200 disclosed herein can include any general-purpose computing device that can manage requests and decisions between automated consumer devices 100, override devices 300, and core decision systems 500.

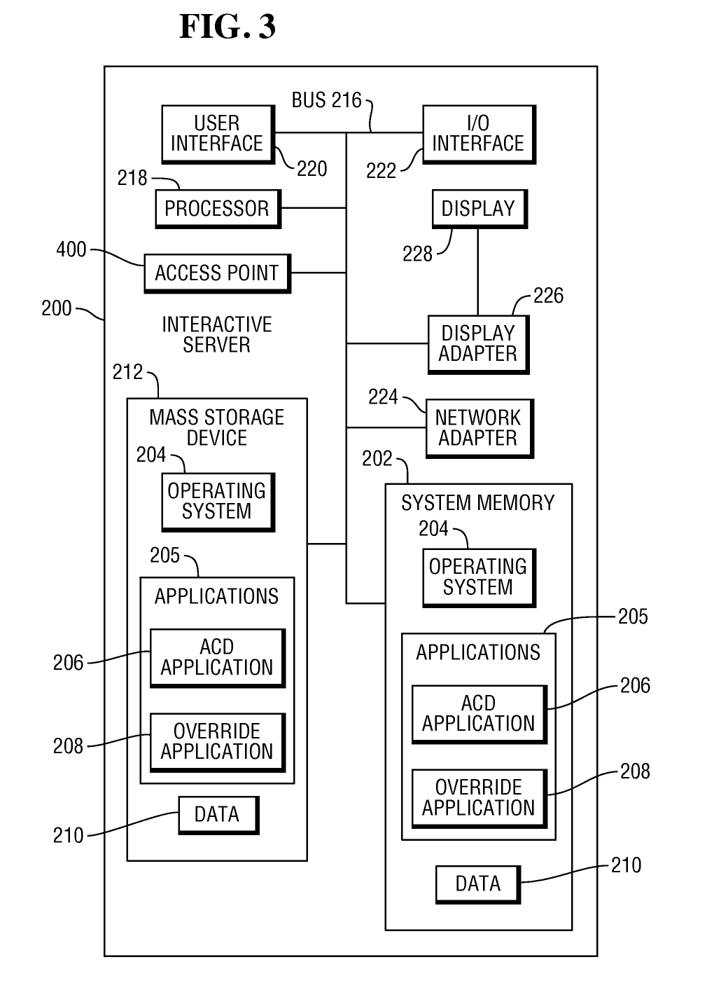

As illustrated in FIG. 3, the interactive server 200 may have several applications 205. The interactive server 200 and its applications 205 may utilize elements and/or modules of several nodes or servers and the like. In an aspect, the interactive server 200 can include many of the same type of components and have a similar configuration as described in reference to the automated consumer device 100 discussed above. However, in any event, the interactive server 200 should be construed as inclusive of multiple modules, software applications, servers and other components that are separate from the automated consumer device(s) 100, the override devices 300, and the core decision systems 500a,b,c. In an aspect, the interactive server 200 can comprise an access point 400, as discussed below. In other aspects, the interactive server 200 and the access point 400 can be separate components.

The interactive server 200 may include a system memory 202 configured to store an operating system 204 and various applications 205. For example, in an aspect, the applications 205 can include an automated consumer device application 206, which is configured to assist with the operation of the automated consumer devices 100. More specifically, the automated consumer device application 206 is configured to facilitate in the transactions requested by the automated consumer devices 100. The automated consumer device 206 is discussed in more detail below.

The interactive server 200 can include an override application 208. The override application 208 is configured to assist in the handling of the requests from users of the automated consumer devices 100 concerning the results of transactions, authorizations, and rejections that are received from the core decision systems 500, and facilitate the overriding of such decisions, if allowable, based upon the information obtained from the override device 300. In an aspect, the override application 208 is configured to provide information and rules (both discussed in more detail below) from all core decision systems 500 to the override device 300. In an aspect, the override application 208 can be configured to assist in the request of additional information not generally used or utilized by a core decision system 500 when making an initial authorization from the core decisions systems 500 at the request of the override device 300.

The interactive server 200 may also include data 210 that is accessible by the applications 205. The data 210 can include the information and rules provided by the core decision systems 500 as discussed above. The interactive server 20 may include a mass storage device 212, on which data 210 can be stored. In addition, the mass storage device 212 can be used for storing computer code, computer readable instructions, program modules, and various databases. The mass storage device 212 can be used to back up or alternatively to run the operating system 204 and/or other applications 205. The mass storage device 212 may include a hard disk, various magnetic storage devices such as magnetic cassettes or disks, solid state-flash drives, CD-ROM, DVDs or other optical storage, random access memories, and the like.

The interactive server 200 may include a system bus 216 that connects various components of the interactive server 200 to the system memory 202 and to the mass storage device 212, as well as to each other. Other components of the interactive server 200 may include one or more processors or processing units 218, a user interface 220 and an input/output interface 222 to which interactive server 200 may connect. In addition, interactive server 200 may include a network adapter 224 that is configured to communicate with other devices over various networks, including, but not limited to, IP networks of various types. In addition, the interactive server 200 may include a display adapter 226 that communicates with a display device 228, such as a computer monitor or other similar devices that present images and text in various formats. A system administrator can interact with the interactive server 200 through one or more input devices (not shown), which include, but are not limited to, a keyboard, a mouse, a touch-screen, a microphone, a scanner, a joystick, and the like, via the user interface 220.

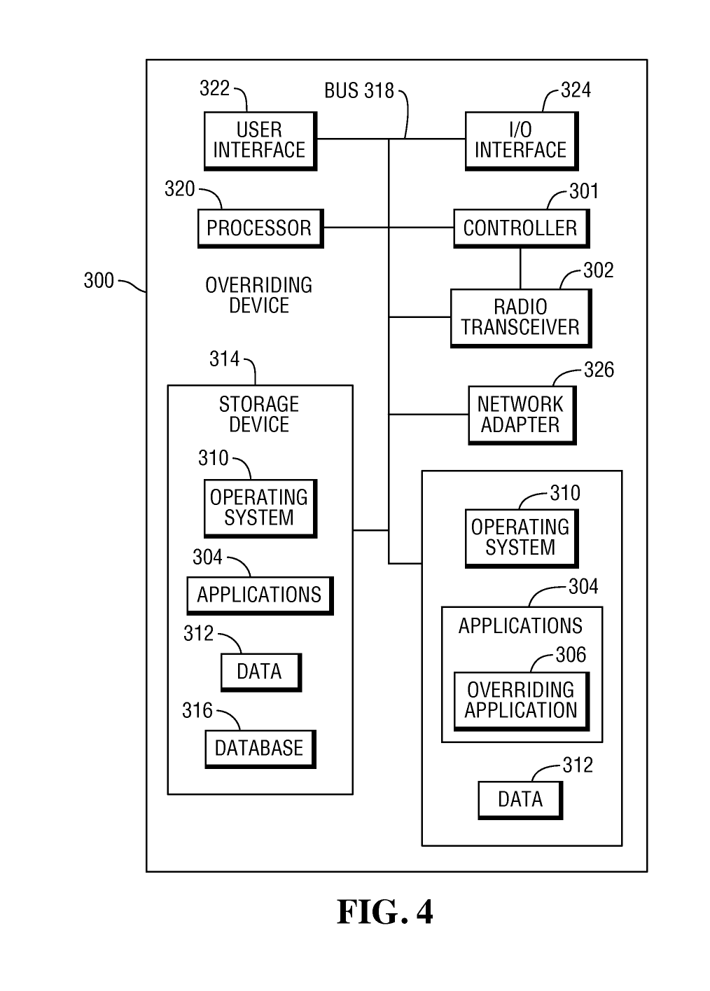

Referring to FIGS. 1 and 4, the interactive server 200 communicates with the override device 300. The override device 300 can include, but is not limited to, tablets, smart phones, PC computers, and other computing devices that can be configured to run various applications. The override device 300 can include any computing device that is connected to the interactive server 200 to assist with the request of an automated consumer device 100 to review and potentially override the decisions rendered by the core decision systems 500, discussed in more detail below.

In an aspect, the override device 300 is configured to be used by an administrator that has institutional knowledge that corresponds to the institution associated with the automated rules-driven override system 10. For example, when the automated rules-driven override system 10 is utilized by a banking institution, the administrator is familiar with the procedures and regulations of the banking institution, and can use this knowledge when assisting consumers with their transactions through the override device 300. In an aspect, the administrator can use an overriding application 306 associated with the override device 300 in the overriding of decisions. In an aspect, the overriding application 306 can be configured to notify the administrator when a request for assistance is received from the override application 208 of the interactive server 200. The overriding application 306 can be further configured to have the administrator confirm or claim the receipt of the request to notify the automated consumer device 100, the interactive server 200, and other override devices 300, if multiple are deployed, that the request is being handled. In an aspect, the overriding application 306, with assistance from the override application 208, can be configured to allow for the monitoring of transactions of the automated consumer devices 100 before a request for assistance is made.

The override device 300 may have one or more software applications 304, including the overriding application 306. The override device 300 includes system memory 308 that can store the various applications 304, including, but not limited to, the operating system 310 of the override device 300 and the overriding application 306.

In an aspect, the overriding application 306 can perform the same duties and functions of the override application 208, but solely on the override device 300. However, in one aspect, the overriding application 306 of the override device 300 is an extension of the override application 208 of the interactive server 200, and is only a web-browser application that provides access to the override application 208 on the interactive server 200. By limiting the overriding application 306 to just a web browser application, security issues can be avoided, as well as limiting the software and performance capabilities needed on the override device 300. In another aspect, the override device 300 can include security features (e.g., login authentication) before allowing a user to operate any applications of the override device 300, including the overriding application 306. In such an aspect, the login information can be utilized to identify the specific administrator operating the given override device 300.

In an aspect, the override device 300 can include a controller 301 and a radio transceiver 302 to allow wireless communication with the interactive server 200. The system memory 308 may also include data 312 accessible by the various software applications. The system memory 308 can include random access memory (RAM) or read only memory (ROM). Data 312 stored on the override device 300 may be any type of retrievable data. The data may be stored in a wide variety of databases, including relational databases, including, but not limited to, Microsoft Access and SQL Server, MySQL, INGRES, DB2, INFORMIX, Oracle, PostgreSQL, Sybase 11, Linux data storage means, and the like.

The override device 300 can include a variety of other computer readable media, including a storage device 314. The storage device 314 can be used for storing computer code, computer readable instructions, program modules, various databases 316, and other data for the mobile device 30, and the storage device 314 can be used to back up or alternatively to run the operating system 310 and/or other applications 304. The storage device 314 may include a hard disk, various magnetic storage devices such as magnetic cassettes or disks, solid-state flash drives, CD-ROM, DVDs or other optical storage, random access memories, and the like. In an aspect, the storage device 314 can be limited in what information and applications 304 is stored for security reasons.

The override device 300 may include a system bus 318 that connects various components of the override device 300 to the system memory 308 and to the storage device 314, as well as to each other. Other components of the override device 300 may include one or more processors or processing units 320, a user interface 322, and an input/output interface 324. In addition, the override device 300 may include a network adapter 326 configured to communicate with other devices over various networks. In an aspect, the combination of the controller 300 and radio transceiver 302 can be utilized to communicate with the interactive server 200 over various wireless networks. As discussed below, the override device 300 utilizes the interactive server 200 to communicate with the core decision systems 500.

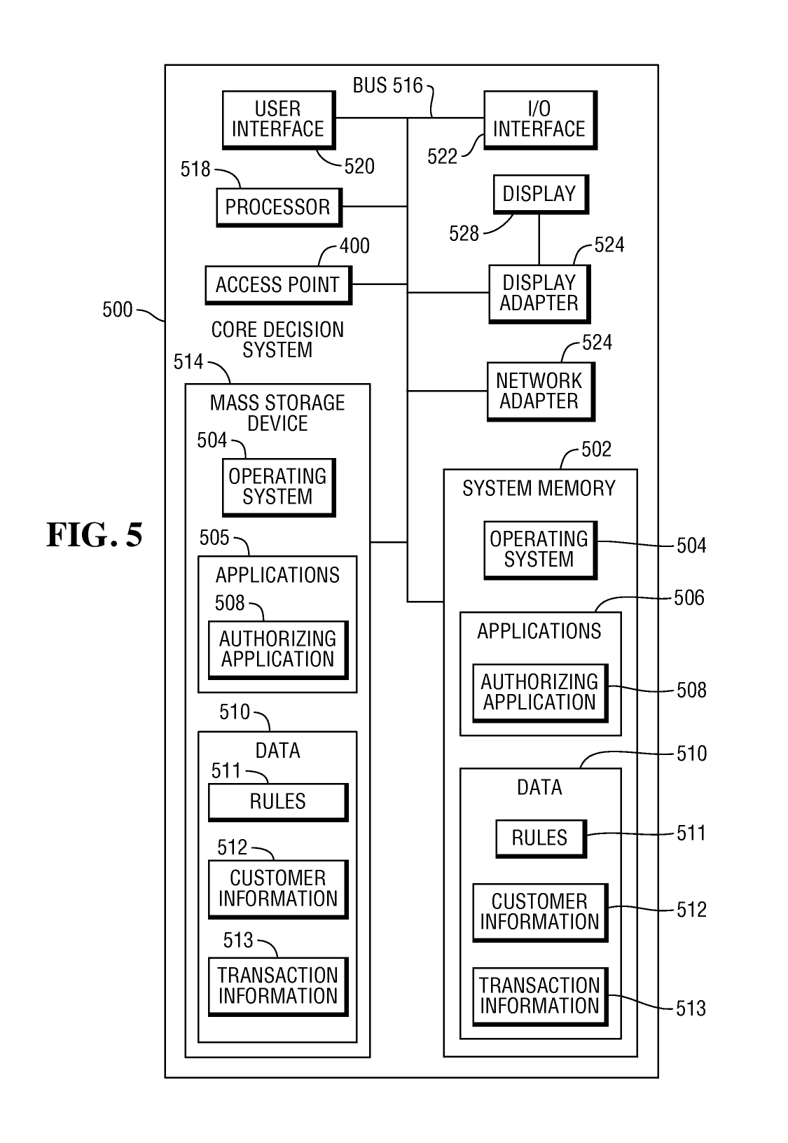

Referring to FIGS. 1 and 5, the core decision systems 500 are utilized to authorize or deny requests from consumers utilizing the automated consumer device 100. In an aspect, the core decision systems 500 are systems that an institution utilizes in carrying out the necessary decisions to operate their business. The types of core decision systems 500 can vary depending on the type of institution utilizing the automated rules-driven override system 10. For example, when the institution is a bank, the core decision systems 500 can comprise a customer lookup system (i.e., a system that includes relevant information to customers, including names, addresses, family members, and other information related to the client), an authentication system, an account database (i.e., a system that organizes the accounts of individuals, the types of accounts, the balances of those accounts, and other features and services associated with the accounts), transaction authorization systems, and the like. In addition, the core decision systems 500 can include administrator database systems which are used to identify administrators of the institutions that can utilize the override devices 300. Such administrator database systems 500 can keep track of the experience level of a given administrator, as well as authorization levels, which can be used in the override operation discussed in more detail below.

In an aspect, the core decision systems 500 can include applications 506, including authorization applications 508. The core decision system 500 and its applications 506 may utilize elements and/or modules of several nodes or servers and the like. In any event, the core decision system 500 should be construed as inclusive of multiple modules, software applications, servers and other components that are separate from the components discussed in detail above. In an aspect, the automated rules-driven override system 10 can include multiple core decision systems 500,a,b,c. However, the core decision system 500 of FIG. 5 is representative of all.

The core decision system 500 can include a system memory 502 configured to store an operating system 504 and various applications 506. The core decision system 500 may also include data 510 that is accessible by the applications 506. In addition, the data can include rules 511, customer information 512, and transaction information 513, as well as other information (e.g., the amount of money available with a particular automated consumer device 100).

In an aspect, the rules 511 can be any predetermined rules 511 that dictate the result of a request based upon the information made available to the authorization application 508. The types of rules 511 and how the rules 511 are implemented correspond to the industries in which the core decision systems 500 are being utilized. For example, when the automated rules-driven override system 10 is utilized by banking institutions for regulating the release of deposited money, the rules 511 can be based upon the deposit types and related consumer information. For example, these rules can follow the regulation and guidelines required by the United States Federal Reserve. These rules may include, but are not limited to, requiring certain types of deposits to be funded almost immediately such as commercial moneys issued by the U.S. government (e.g., cash, treasury checks, postal checks, etc.), cashiers, certified and/or teller's checks, and on-us checks, of funds that can be delayed, such as large deposits, re-deposited checks, new accounts, and deposits of accounts that are repeatedly overdrawn. More examples of these rules can be found at http://www.federalreserve.gov/pubs/regcc/regcc.htm. In other automated rules-driven override systems 10, other types of rules 511 can be utilized.

In another aspect, the rules 511 can have various enforcement levels. The rules can be flexible or can be inflexible dependent on the request/transaction. For example, the rules 511 can be considered to be recommendations that are suggested based upon limited information that can be adjusted or changed upon the addition of other information or justifications, which can be supplied through the override device 300 (discussed in more detail below). In addition, the rules can be considered strictly enforced, regardless of input and other information collected by the override device 300. The potential adjustment to the rules 511 will be discussed in more detail below.

In an aspect, the authorization application 508 also uses additional data 510, including customer information 512 and transaction information 513 in conjunction with the rules 511, to authorize or deny a request submitted by the automated consumer device 100. In an aspect, customer information 512 and transaction information 513 can be provided to the authorization application 508 with the request that comes from the automated consumer device 100 from the automated device application 206 of the interactive server 200 via the access point 400. Further, the authorization application 508 can confirm authorization based upon information provided by the override application 208 of the interactive server 200, which was gathered or collected from the override application 306 of override device 300, discussed in more detail below.

The core decision system 500 may include a mass storage device 514, on which data 510 can be stored. In addition, the mass storage device 514 can be used for storing computer code, computer readable instructions, program modules, and various databases. The mass storage device 514 can be used to back up or alternatively to run the operating system 504 and/or other applications 506. The mass storage device 514 may include a hard disk, various magnetic storage devices such as magnetic cassettes or disks, solid state-flash drives, CD-ROM, DVDs or other optical storage, random access memories, and the like.

The core decision system 500 may include a system bus 516 that connects various components of the core decision system 500 to the system memory 502 and to the mass storage device 514, as well as to each other. Other components of the core decision system 500 may include one or more processors or processing units 518, a user interface 520 and an input/output interface 522 to which the interactive server 200 via the access point 400 may connect. In addition, core decision system 500 may include a network adapter 524 that is configured to communicate with other devices over various networks. The core decision system 500 may include a display adapter 526 that communicates with a display device 528, such as a computer monitor or other similar devices that present images and text in various formats. A system administrator can interact with the core decision system 500 through one or more input devices (not shown), which include, but are not limited to, a keyboard, a mouse, a touch-screen, a microphone, a scanner, a joystick, and the like, via the user interface 520.

Referring to FIGS. 1 and 3, the automated rules-driven override system 10 can include an access point 400. As discussed above, the access point 400 can be contained within or associated with the interactive server 200. In other aspects, the access point 400 can comprise a server that operates in conjunction with the interactive server 200. The access point 400 is configured to direct the communications from the automated consumer device 100 and override device 300, via the interactive server 200, to the correct core decision systems 500 for fulfillment. More specifically, the access point 400 is configured to direct the transaction requests and the override requests, as well as the responses to the requests (i.e., authorization, rejections, etc.) to and from the appropriate core decision systems 500. The access point 400 can contain modules and logic that allows the access point 400 to identify the correct core decision system 500 based upon information found in the request. In an aspect, the access point 400 can be configured to monitor all transaction requests, and based upon the type of transaction requested, which includes information relevant to the transaction, and other included information, direct the request to the corresponding core decision system 500.

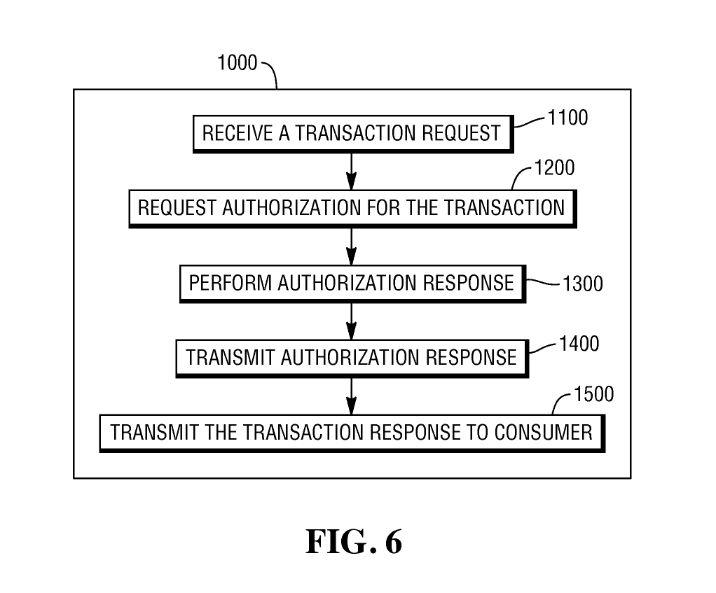

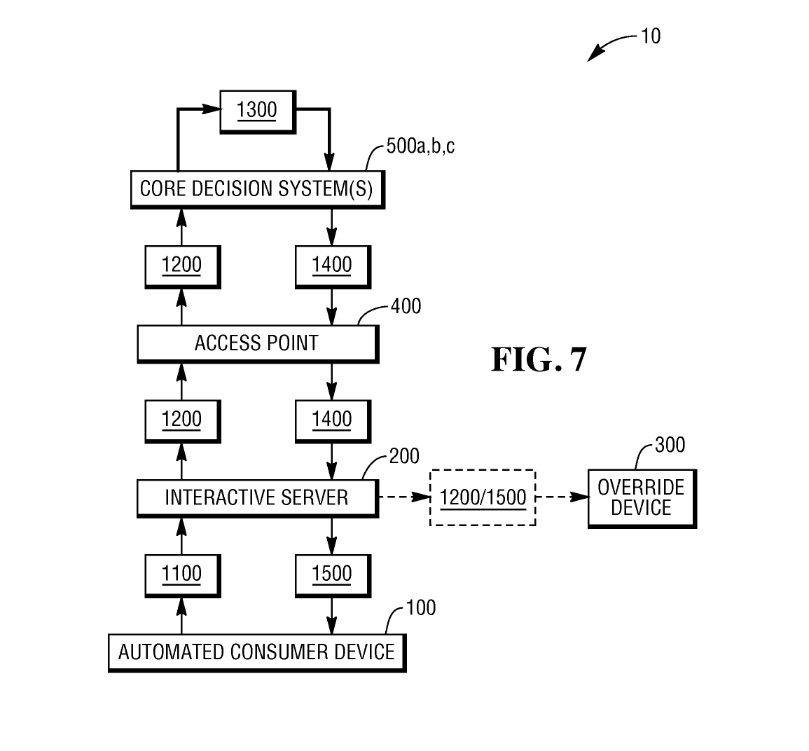

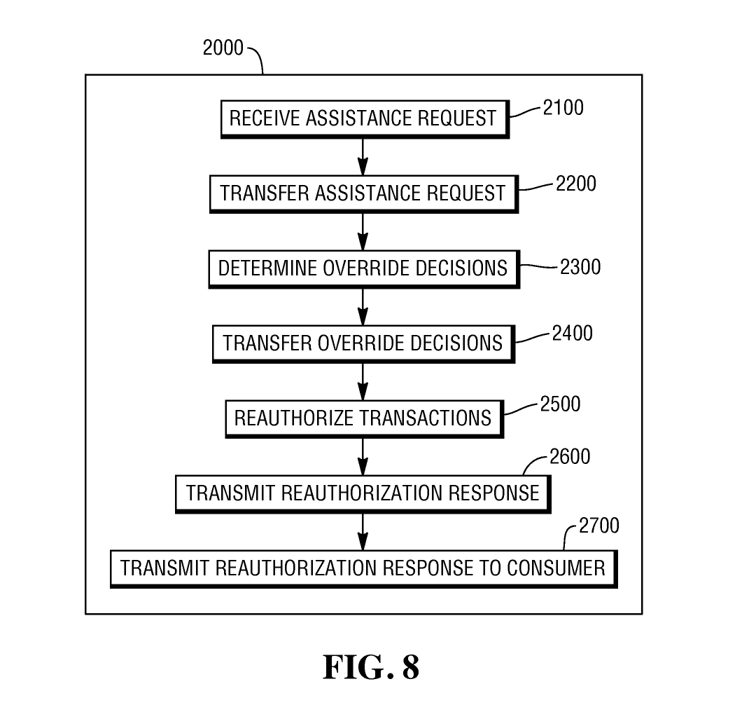

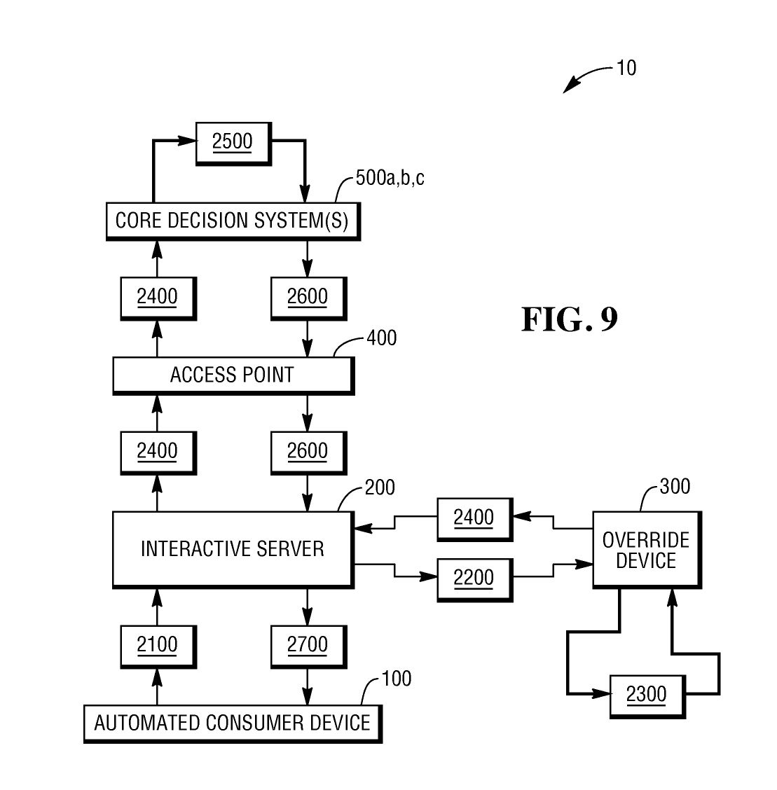

In an aspect, the automated rules-driven override system 10 can be configured to carry out traditional automated rules driven decisions depicted in method 1000, as shown in FIGS. 6-7, and overriding decisions, as shown in FIGS. 8-9, depicted in method 2000.

As shown illustrated in FIGS. 6-7, the automated rules-driven override system 10 can carry out transactions using traditional automated rules driven decisions (method 1000) by generating and transmitting a transaction request from a consumer (step 1100), requesting authorization for the transaction (step 1200), performing the authorization, transmitting the authorization in a response (step 1400), and transmitting the transaction response to the consumer (step 1500).

In an aspect, the transaction application 108 of the automated consumer device 100 can generate the transaction request (step 1100). The generation of the transaction request can include the automated consumer device 100, through the transaction application 108 collecting needed information to make the transaction request. In an aspect, the automated consumer device 100 can collect/generate customer information 512 and transaction information 513 from a particular session initiated by the consumer. The customer information 512 can include identification information related to the consumer. For example, if the transaction is related to the deposit of checks or other monies into a bank account, the automated consumer device 100 can require the consumer to supply customer identification, such as a login name or account number (i.e., card number found on debit card) and a corresponding password or other authentication means (e.g., fingerprint, voice recognition, etc.).

In an aspect, the transaction information 513 can include information specific to the transaction being requested. In an exemplary aspect, the transaction information 513 can include what type of transaction is being requested. For example, when the automated consumer device is an ATM, the transaction type can include, but is not limited to, cash deposits, check deposits, withdrawals, account transfers, and the like. The transaction type can be utilized to assist in determining which core decision system 500 to which the request should be directed.

In addition, the transaction information 513 can include other transaction specific information. For example, if the transaction type has been identified as a check deposit, the transaction information can include, but is not limited to, capturing the total number of checks, the amount of each check, the total amount to be deposited by the checks, the quality of the check, check identification information (e.g., check number, bank issuer, source of the check, routing number, etc.), a general risk accuracy score associated with the check (which can be generated by other applications 105 of the automated consumer device 100) generation of transaction related information.

In other embodiments of the present invention, the automated consumer device 100 can collect customer information 512 and transaction specific information 513 that is unique for the use of the automated consumer devices 100. For example, in the use of airline flight check-in kiosks, the information can include a person's passport number and flight number, seat number, number of bags, and other relevant information. In general, the customer information 512 and transaction information 513 can include all information that is essential for the core decision systems 500 to make a decision.

Once the need information is generated and collected, the transaction application 108 of the automated consumer device 100 will then pass along the transaction request to the interactive server 200 (step 1100). In an aspect, the automated consumer device application 206 of the interactive server 200 can collect the information from the request sent from the automated consumer device 100.

The ACD application 206 and/or the override application 208 can then pass along the information to the core decision system(s) 500 via the access point 400 (step 1200). As discussed above, the access point 400 can utilize the information within the request (e.g., the transaction type) to determine which core decision system 500 to which to direct the request. In an aspect, the interactive server 200 can also share the transaction requests received with the override device 300, as shown in FIG. 7 and discussed above.

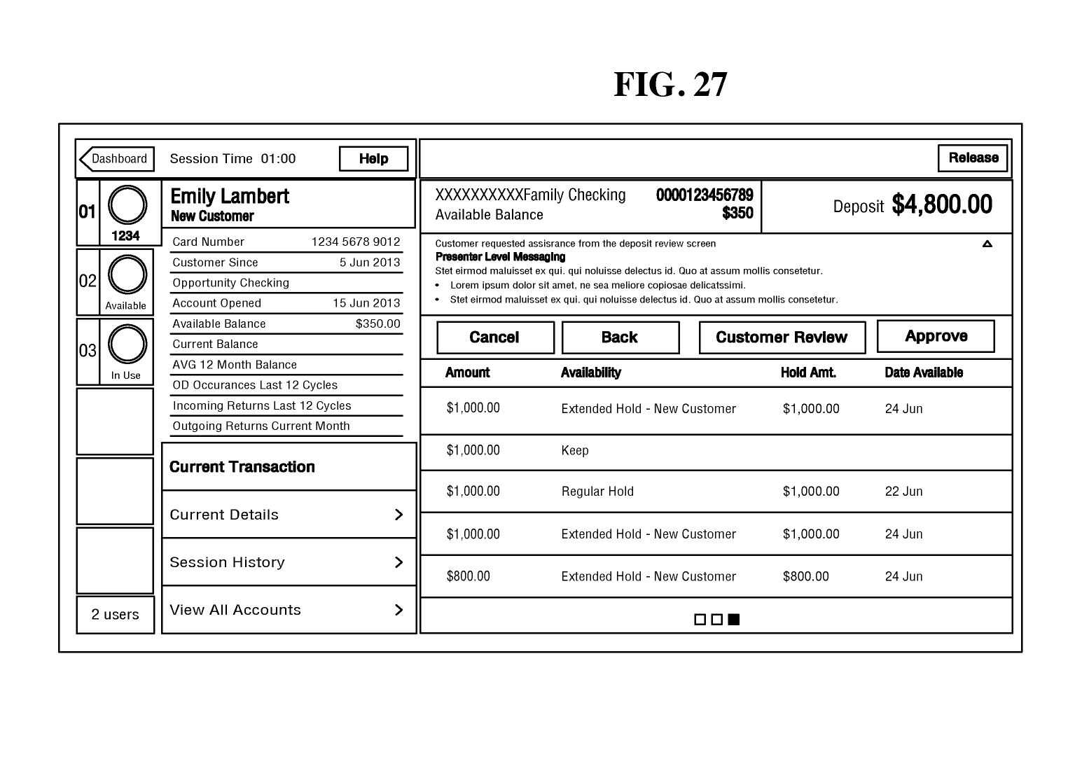

Upon receipt, the core decision system(s) 500 can then determine whether or not to authorize the requested transaction (step 1300). As stated above, the authorization application 508 can turn to the information provided in the request, including customer information 512 and transaction information 513, as well as rules 511 and any other associated customer information 512 and transaction information 513 that is accessible on the core decision system 500. Once determined, the authorization application 508 of the core decision systems 500 can transmit the authorization response to the interactive server 200 via the access point 400 (step 1400). Upon receipt of the response, the server 200 can pass along authorization response to the automated consumer device 100 (step 1500). In an aspect, the override application 208 can share the information with the override device 300, as shown in FIG. 7 and discussed above. Once the automated consumer device 100 receives the response, the consumer can look to see if the response is satisfactory. In an example, as shown in FIG. 27, the consumer can be provided a customer review summary to see if the response is satisfactory.

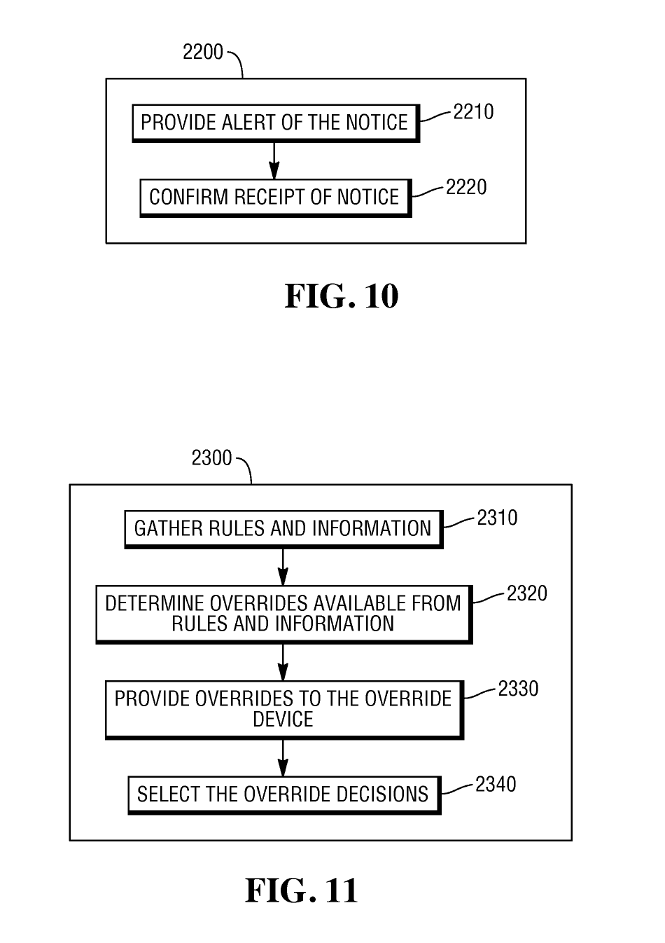

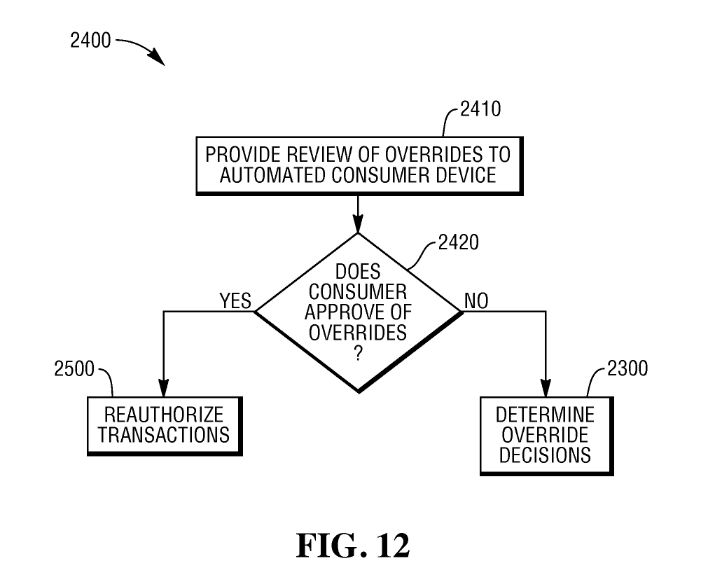

If the consumer finds the response unsatisfactory, the consumer can call upon the automated rules-driven override system 10 to override the response (method 2000), as shown in FIGS. 8-9. In an aspect, the automated rules-driven override system 10 can receive a request for assistance (step 2100), transfer the assistance requests to the override device 300 (step 2200), determine the override decisions (step 2300), transfer the override decisions to the core decision systems 500 (step 2400), reauthorize the transactions based on the submitted override decisions (step 2500), transmit the reauthorization responses to the interactive server 200 (step 2600) and the consumer (step 2700), as shown in FIGS. 8-12.

In an aspect, the consumer can request assistance from the automated rules-driven override system 10 to override the request (step 2100). The consumer can use the automated consumer device 100 to call for assistance. For example, the consumer can use the user interface 116 of the automated consumer device 100 to issue the request for assistance. The request is then issued to the interactive server 200. In an aspect, the request from the automated consumer device 100 is transmitted to the override application 208 of the interactive server 200.

Upon receipt of the request, the override application 208 of the interactive server 200 can then notify the override device 300 that assistance is needed (step 2200), as illustrated in FIGS. 8-10. In an aspect, the request can include all of the relevant information related to the transaction(s) of which the customer at the automated consumer device 100 has requested assistance. In an aspect, the rules 511, customer information 512, and transaction information 513 can be automatically sent along with the request. In such an aspect, the rules 511, customer information 512, and transaction information 513 can be readily available and accessible on the interactive server 200, or can be requested from the core decision systems 500 via the access point 400. In another aspect, the override application 208, upon receipt of the request from the automated consumer device 100 (step 2100), can be configured to request additional information and rules that were not supplied originally utilized in the original authorization (step 1300).

In an aspect, the notice is configured to alert an administrator associated with the override device 300 of the need for assistance (step 2210). The user interface 322 of the override device 300 can include means to alert the administrator. Once the administrator has received alert, the administrator can then confirm receipt of the request (step 2220). The confirmation can be executed through the overriding application 306 of the override device 300 through means associated with the user interface 322. Further, in an aspect, the confirmation can be sent to the override application 208 of the interactive server 200. The confirmation can be passed along to the override application 208 and shared amongst the various other override devices 300 to alert other administrators that the request has been claimed. In another aspect, the confirmation can also send along the administrator identification information that can be used in the reauthorization transaction (2500) discussed below.

Upon receipt of the confirmation, the override application 208 can then determine the override decisions (step 2300), as shown in FIGS. 8-9 and 11. First, the override application 208 can call upon the automated consumer device 100 and/or the core decision systems 500 to provide the relevant rules 511, customer information 512, and transaction information 513 (step 2310). In an aspect, the override application 208 can call upon all core decision systems 500 that have information and rules relevant to the consumer requesting the assistance. In this aspect, the override application 208 can call upon the access point 400 to determine which core decision systems 500 have information 512, 513 and rules 511 that can have an impact on any overriding decision. The gathering of rules and information (step 2310) can occur upon receiving the request from the automated consumer device (step 2100), or after transferring the assistance request (step 2200) to the override device 300.

In an aspect, after receiving the information from the core decision systems 500 and the automated consumer device 100, the override application 208 can then determine which overrides are available (step 2320). The override application 208 can look to the customer information 512 and transaction information 513 supplied by the core decision systems 500, as well as the automated consumer device 100, to determine what options are available based upon the rules 511 from the various core decision systems 500 that are supplied. In an exemplary aspect, the administrator information, which can be used to identify what authorization level the administrator has, can be used to determine available options. In such an example, the more experience and knowledge that an administrator has about the procedure and rules of the institution, as well as the position of the administrator, the system 10 can be configured to provide greater flexibility in the overrides available. In addition, in some aspects, the override application 208 can also supply acceptable reasons for certain overrides. These reasons, similar to the rules, can be generated by an administrator and stored within the core decision systems 500. The reasons can be associated with the available options and rules.

Once the options of overrides available are determined, the override application 208 can provide the available overrides to the override device 300 (step 2330). In an exemplary aspect, the override application 208 can also provide customer information 512 and transaction information 513 that can be utilized by the override device 300, and more specifically the administrator of the override device 300, to make such make determinations as to which override options can be selected (step 2340). As discussed above, in an exemplary aspect of the present invention, an administrator with institutional knowledge associated with the automated rules-driven override system 10 can utilize such institutional knowledge and information supplied by the override application 208 (i.e., the rules 511, customer information 512 and transaction information 513) in assisting a consumer with selecting the appropriate overrides, if any can be selected. How the administrator can use the override device 300 with the rules 511 and information 512, 513 to select the appropriate override is discussed in detail below.

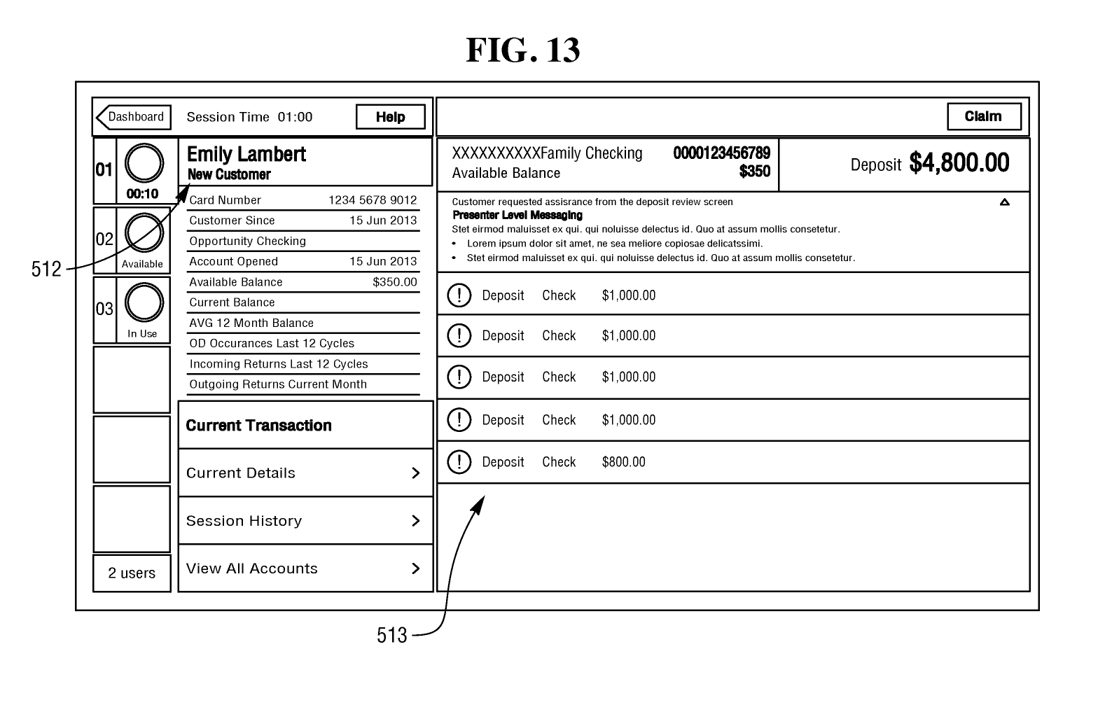

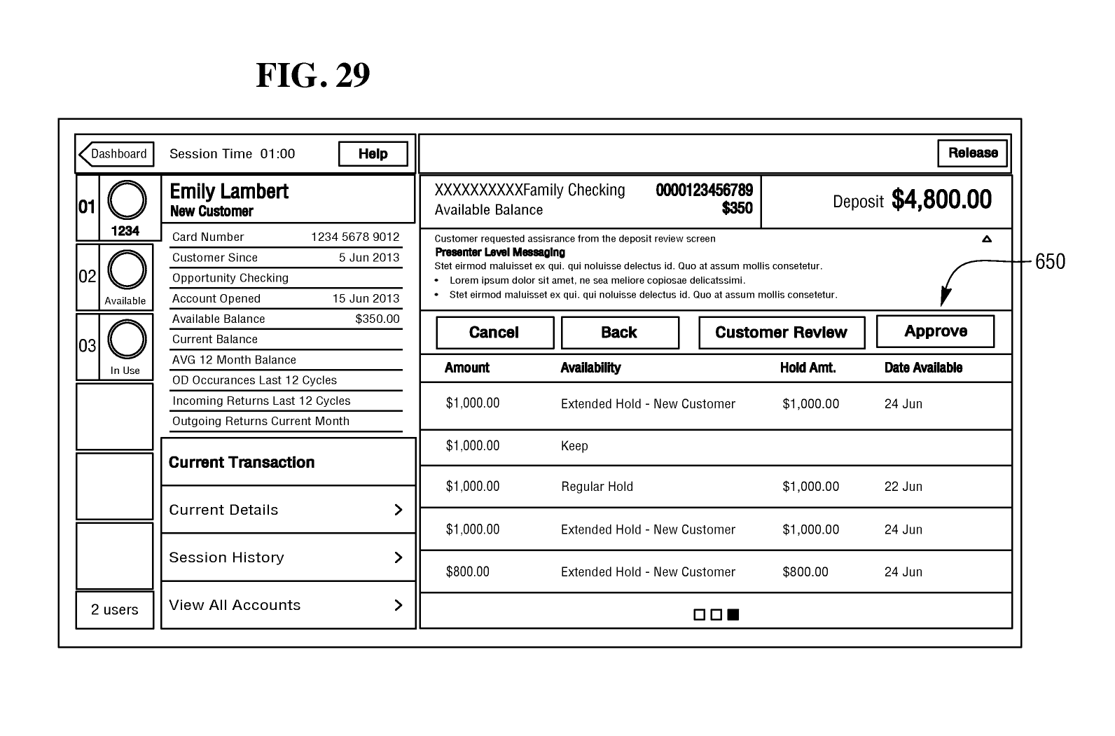

In an aspect, the override application 208 can call upon various APIs to provide the options to the override device 300 via the override application 306. These APIs can include, but are not limited to, .net, Java, Javascript, REST, and the like. In an aspect, the options of overrides are provided in the form of an interactive computer generated display to the override device 300. In an exemplary aspect, the computer generated displays can be presented in the form of a web browser application on the override device 300, as shown in FIGS. 13-30.

Upon completion of the override decisions (step 2340), the override device 300 can transfer the override decisions to the override application 208 of the interactive server 200 (step 2400), as illustrated in FIGS. 8-9 and 12. In an aspect, the selected override decisions can be supplied to the consumer utilizing the automated consumer device (step 2410). Once supplied, the override decisions can be reviewed by the consumer utilizing the automated consumer device 100 (step 2420). If the consumer approves, the transfer override decisions are sent to interactive server 200 to be reauthorized (step 2500). If the consumer does not approve, the consumer can request other overrides to be made (step 2300).

Once the decisions have been approved, the override application 208 can pass along the reauthorization requests to the core decision systems 500 (step 2500). At this point, the core decision systems 500 will pass along the decisions made to the authorization application 508 of the relevant core decision system 500 to determine if the override provided, along with accompanying information and reasoning, is acceptable. In an aspect, the core decision systems 500 can perform this step in a similar fashion as described in step 1300 above. The authorization application 508 can turn to the information provided in the override decision, including customer information 512, transaction information 513, rules 511, and the reasoning provided by the administrator, via the override device 300, and any other associated customer information 512 and transaction information 513 that is accessible on the core decision system 500. As discussed above, the authorization application 508 can also take into account the knowledge and authority level of the administrator making the override request when making the reauthorization decisions.

Once determined, the authorization application 508 of the core decision systems 500 can transmit the authorization response to the interactive server 200 via the access point 400 (step 2600). Upon receipt of the response, the server 200 can pass along authorization response to the automated consumer device 100 (step 2700). Upon receipt, the consumer can accept the authorization, or request additional overrides or options (returning to step 2300).

FIGS. 13-30 illustrate an exemplary example of how the automated rules-driven override system 10 can be utilized by a banking institution to assist a customer in making overrides after depositing checks (step 2340). More specifically, FIGS. 13-30 illustrate the decision making process taking place on the override device 300 that comprises a tablet 300.

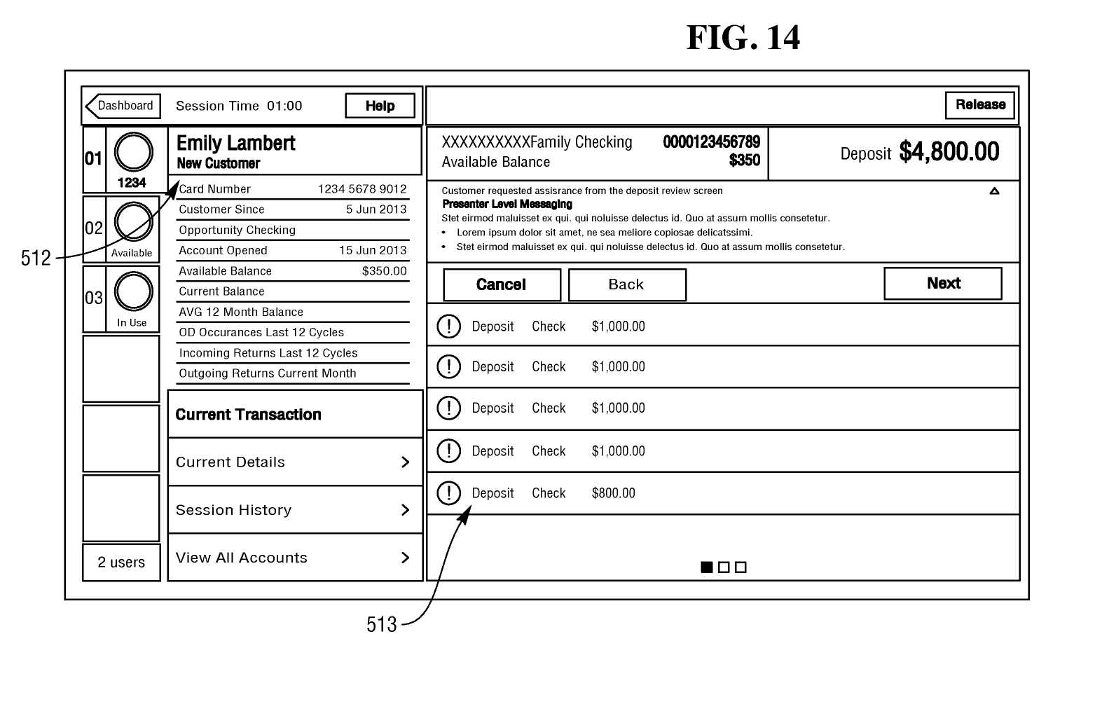

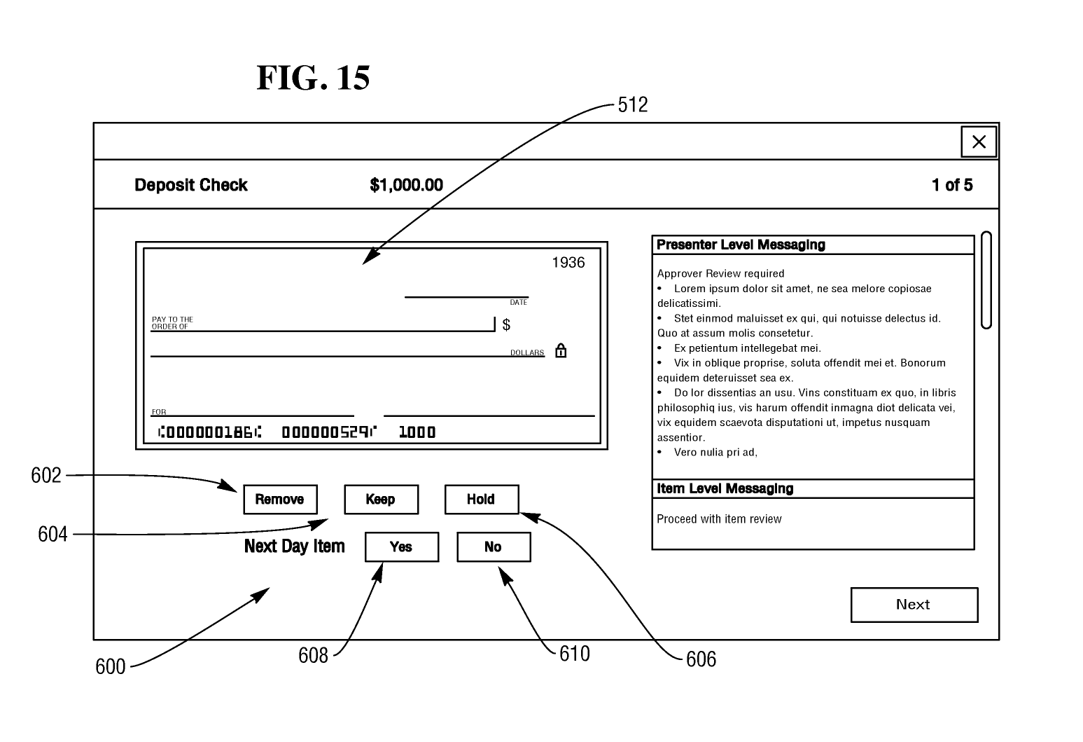

As shown, the process is carried out through interactive computer generated displays generated by a web browser 306. The web browser 306 displays customer information 512 (e.g., how much money is available in the account) as well as transaction information 513. Other useful information can be displayed as well. For example, the display can include means for an administrator to confirm (e.g., selection of the claim tab) the request to the system 10. Upon confirmation, the administrator can then be displayed as handling the request, as shown in FIG. 14. As shown in FIGS. 13-14, the administrator can then look to see relevant information for each check, as well as the potential overrides 600 available for each check. As shown in FIG. 15, the overrides 600 available are remove 602 (i.e., the check will be removed) keep 604 (i.e., the check will be returned to customer), and hold 606 (i.e., check is retained by bank, hold is put on the check until cleared). In addition, the administrator can determine if the money corresponding to the check should be made available to the consumer the next day (selection of next day 608), or if a hold should occur (610).

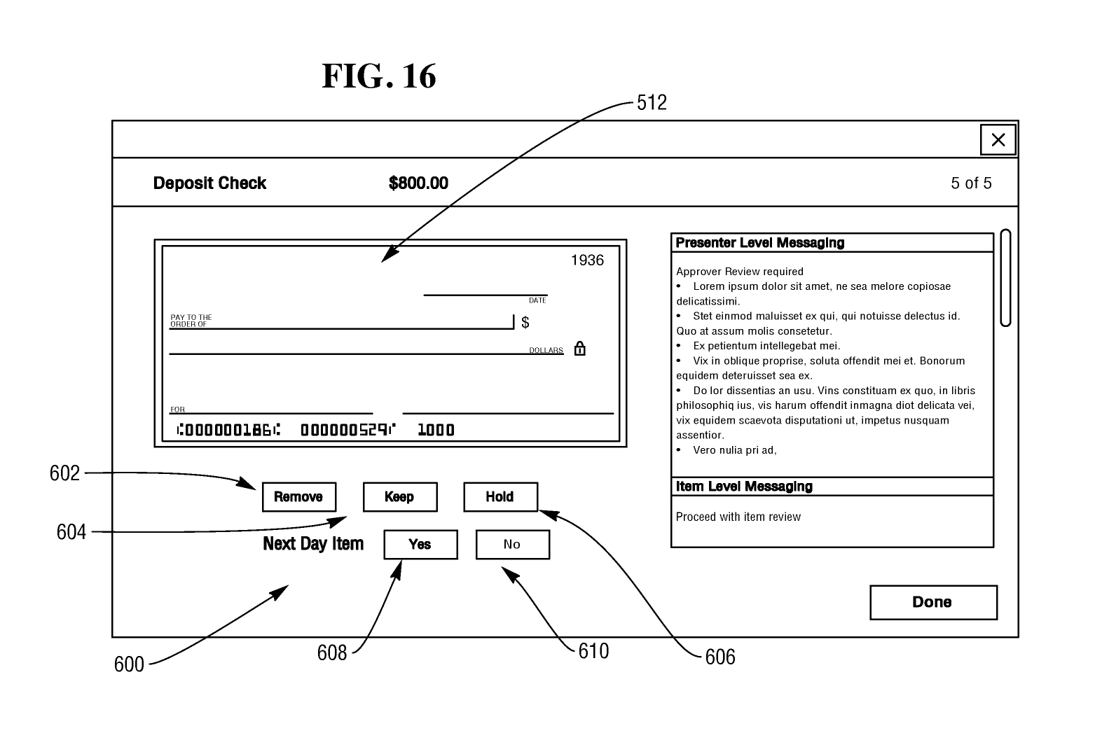

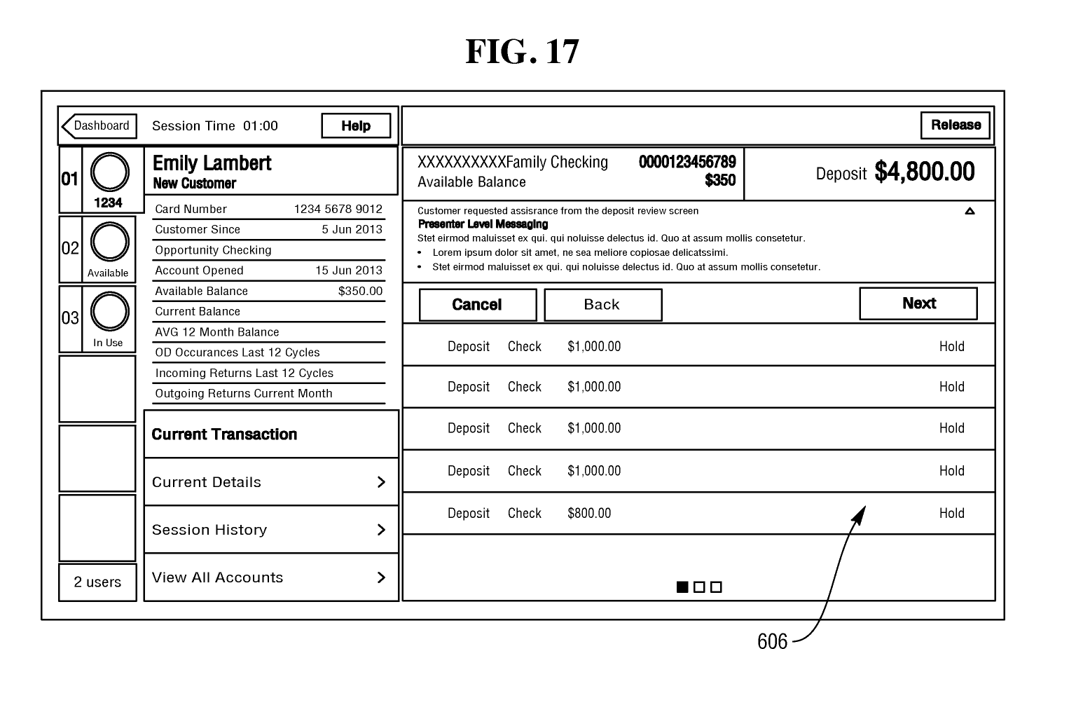

If the administrator wants to hold the check, the administrator it should be held until the next day 608, or for longer 610, as shown in FIG. 16. Once the selections have been made, they can be displayed to the administrator, as shown in FIG. 17. As shown, all five checks have been given a hold 606.

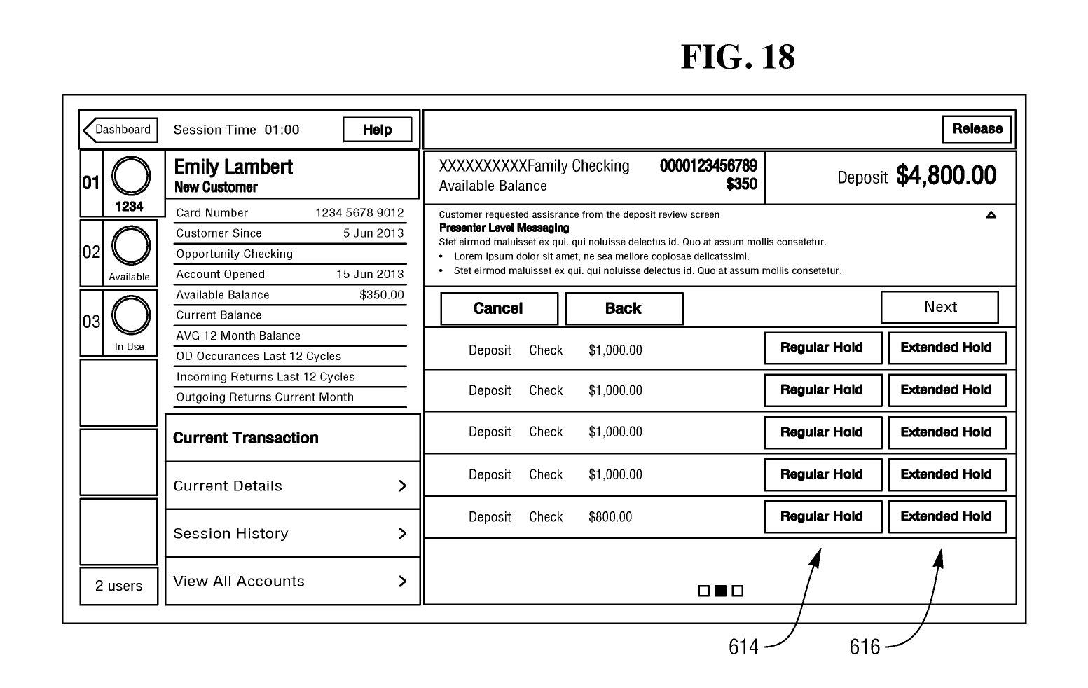

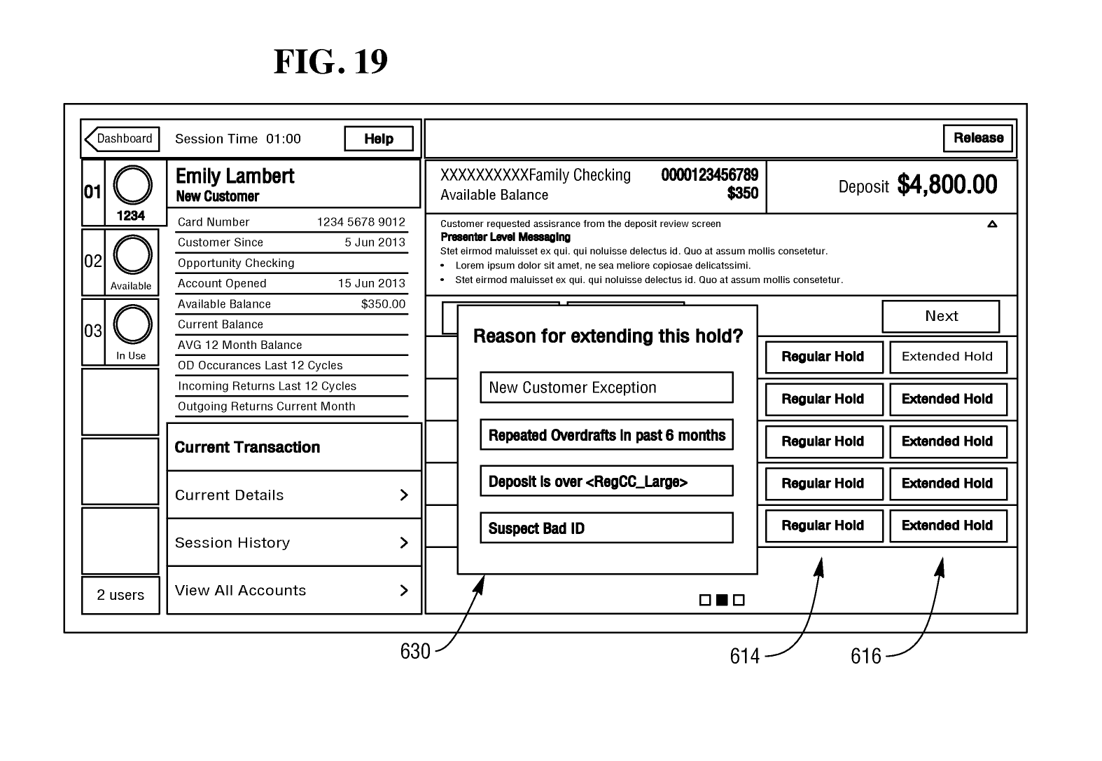

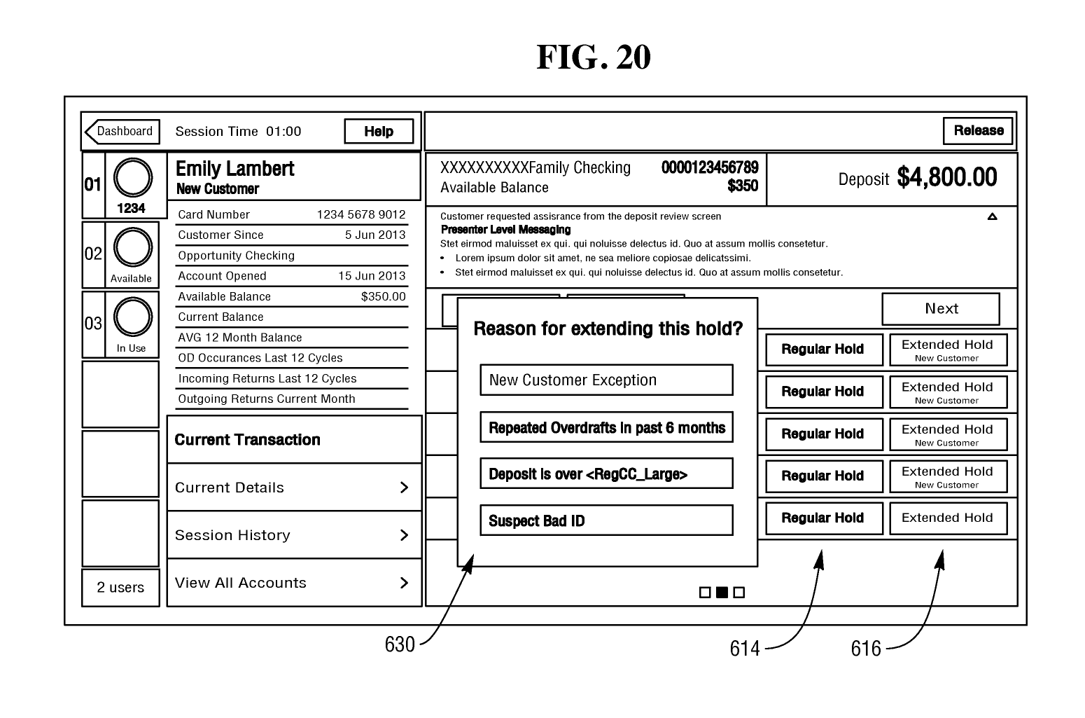

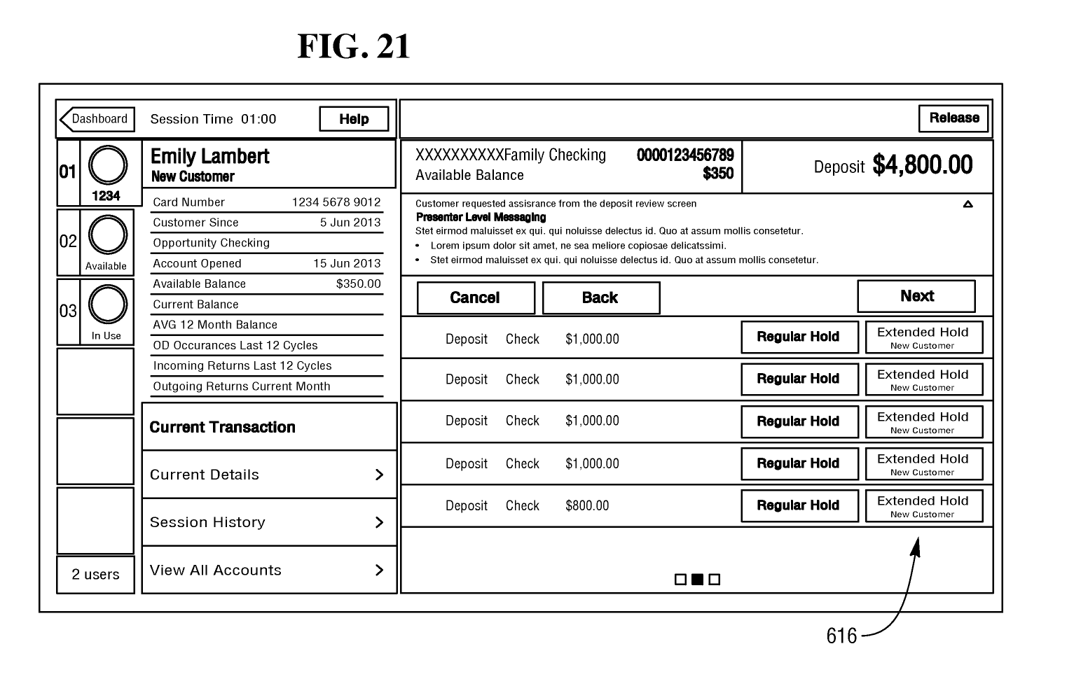

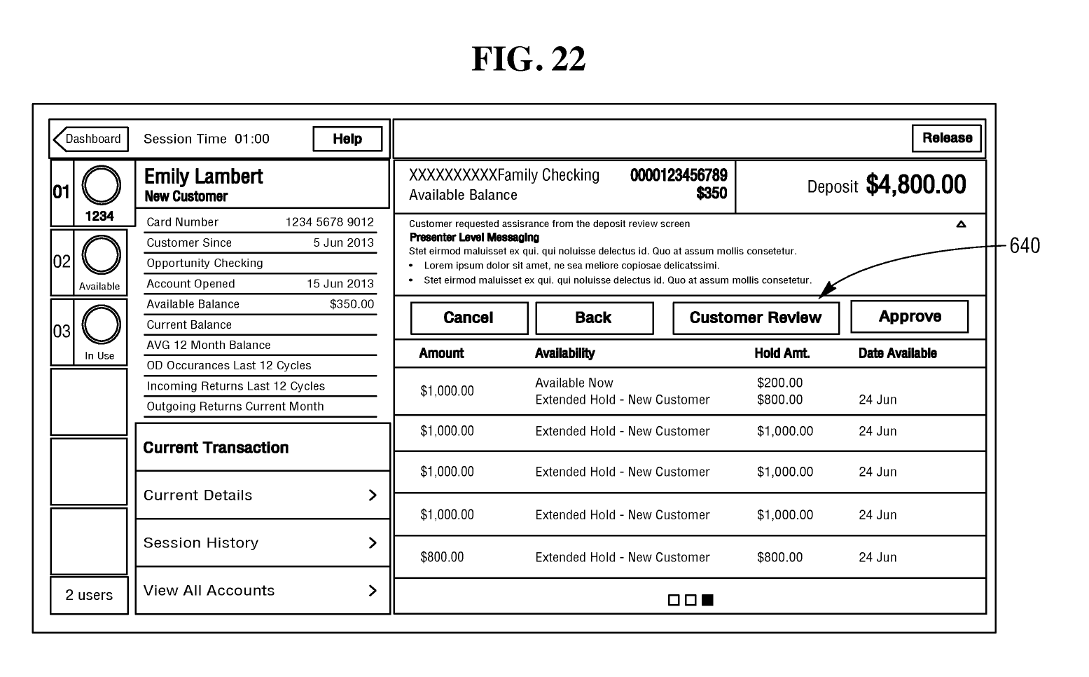

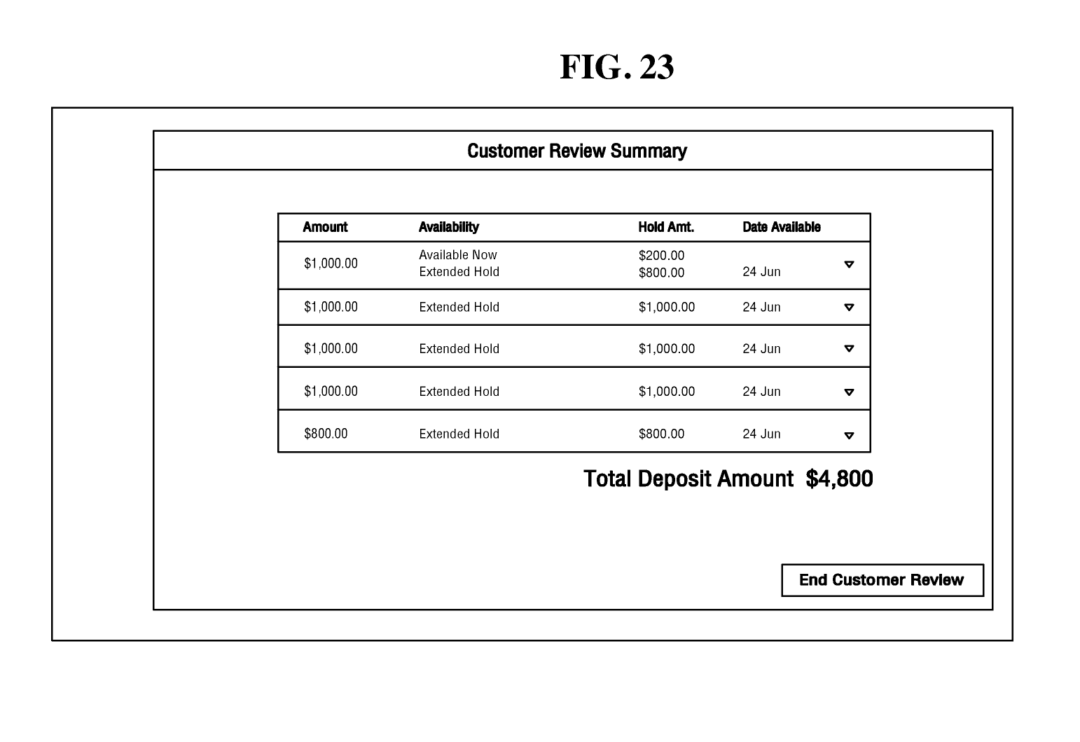

As shown in FIGS. 18-21, the administrator can also determine whether or not the hold should be a regular hold 614 or an extended hold 616. Further, the administrator can also provide reasons 630 as to why to have an extended hold 616, as shown in FIGS. 19-20. Once the administrator has made the hold decisions (as shown in FIG. 21), the override device 300 can provide a review screen of the decisions, as shown in FIG. 22. If the administrator is satisfied with the selections, the administrator can review to the customer by selecting a customer review option 640, which provides a summary (FIG. 23) to the customer.

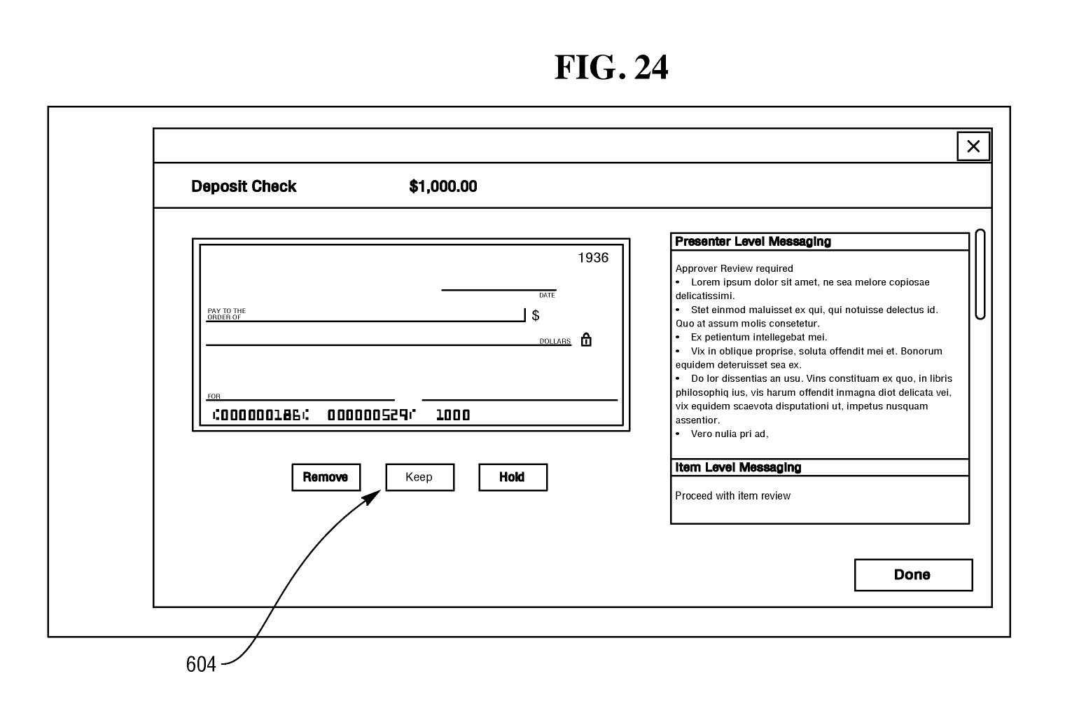

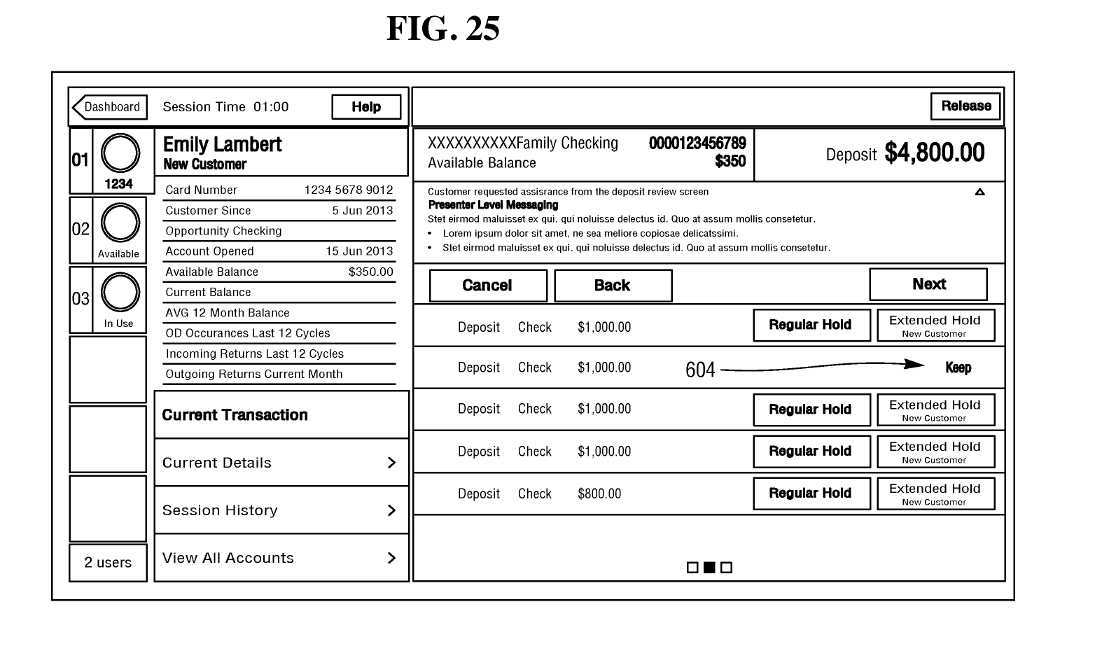

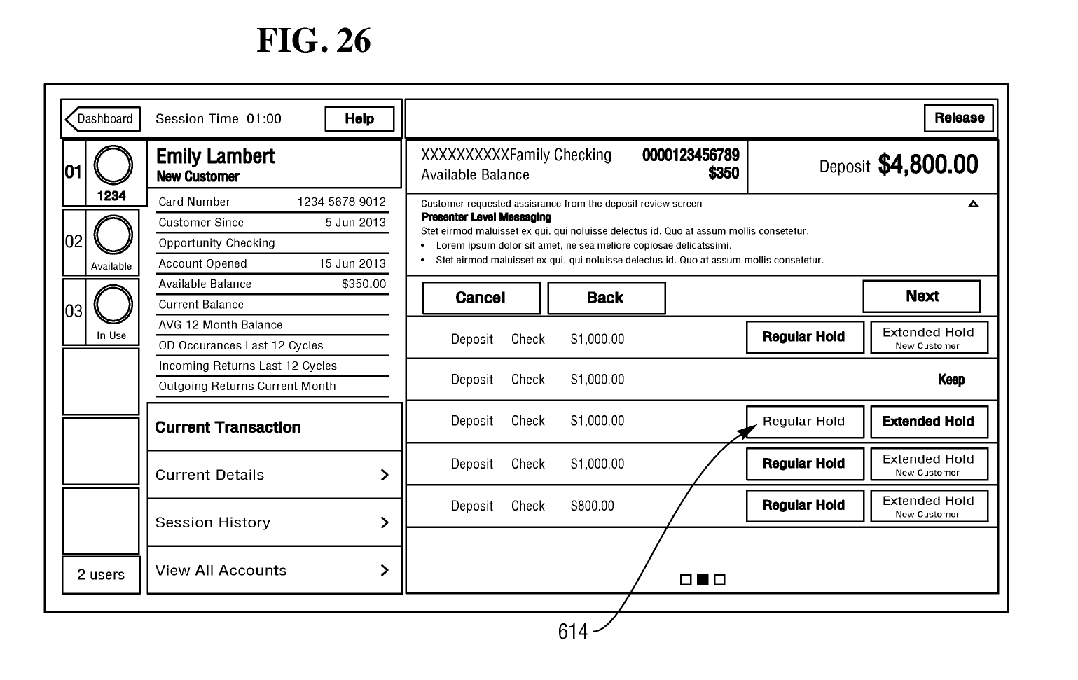

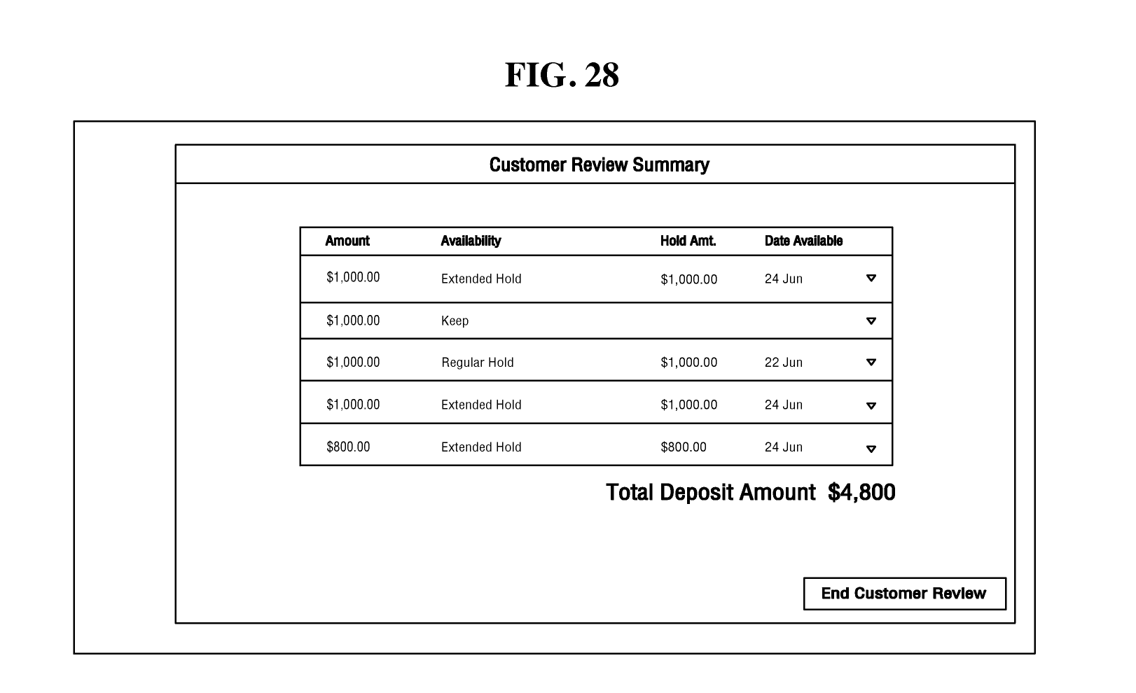

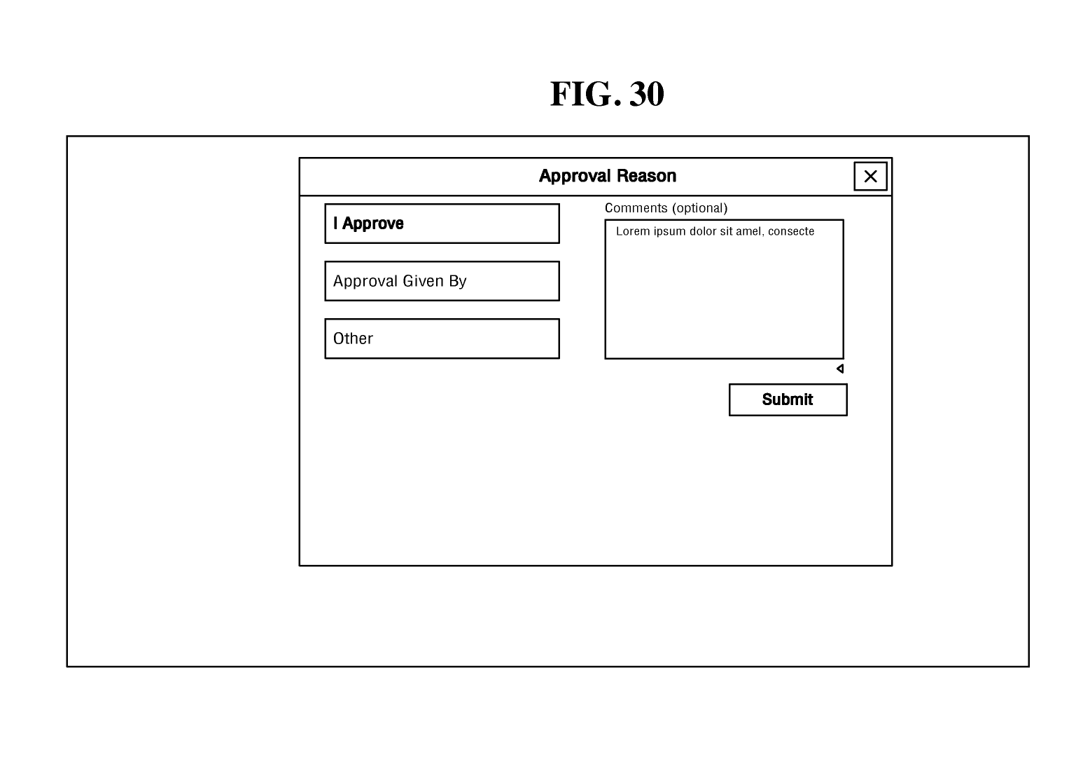

If the customer wants to select different overrides after the review of the summary, the administrator can revisit decisions shown in FIG. 21, and select the desired checks to which the changes need to be made. For example, as shown in FIGS. 24-25, the customer can choose to have the check returned (selection of keep 604). In addition, the administrator can revisit the selections previously made based upon customer changes. For example, as shown in FIGS. 26-27, the administrator can change the selection of a hold to a regular hold for a consumer. Upon completion, a new customer review summary (FIG. 28) can be provided to the customer. Once accepted by the customer, the administrator can then provide his or her approval to the system by selecting the approval tab 650, as well as the reasons for the approvals, if any additional are needed, to the system 10, as shown in FIG. 30.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

1. A system for overriding a rule-driven decision, comprising:
a consumer device for generating a transaction request to perform a selected transaction;
a decision device for receiving the transaction request from the consumer device, the decision device authorizing or rejecting the transaction request based on at least one rule; and
an override device for:
receiving an override request sent from the consumer device when the decision device rejects the transaction request, and
when override conditions are met, causing the decision device to authorize the transaction request that was previously rejected based at least in part on the override request sent from the consumer device.

2. The system of claim 1, wherein the consumer device comprises an automated teller machine.

3. The system of claim 1, wherein the consumer device comprises a kiosk.

4. The system of claim 1, wherein the transaction request generated by the consumer device comprises a release of funds associated with a check deposit.

5. The system of claim 4, wherein the at least one rule comprises United States Federal Reserve rules.

6. The system of claim 1, wherein the override device determines whether the override conditions are met based on information associated with one or more of the following: a user of the consumer device and the transaction request.

7. The system of claim 1, wherein the override device causes the decision device to authorize the requested transaction, in response to an administrator of the override device.

8. A method for overriding a rule-driven decision, comprising the steps of:
receiving a transaction request to perform a selected transaction, the transaction request sent from a consumer device;
authorizing or rejecting the transaction request based on at least one rule; and
receiving an override request sent from the consumer device when the transaction request was rejected, and
when override conditions are met, re-authorizing the transaction request that was previously rejected based at least in part on the override request sent from the consumer device.

9. The method of claim 8, wherein the receiving step receives the transaction request from an automated teller machine.

10. The method of claim 8, wherein the receiving step receives the transaction request from a kiosk.

11. The method of claim 8, wherein the transaction request received from the consumer device comprises a release of funds associated with a check deposit.

12. The method of claim 11, wherein the at least one rule comprises United States Federal Reserve rules.

13. The method of claim 8, wherein the re-authorization of the transaction request in response to override conditions being met occurs based on information associated with one or more of the following: a user of the consumer device and the transaction request.

14. The method of claim 8, wherein the re-authorization of the transaction request in response to override conditions being met occurs in response to an administrator of the override device.

15. A method of overriding an automated transaction decision, the method comprising: receiving information indicating that a transaction request is, at least in part, declined; and
transmitting an approval to a customer terminal so that the transaction request is fulfilled by the customer terminal.

16. A method according to claim 15, wherein receiving information indicating that the transaction request is, at least in part, declined includes receiving this information from the authorization host.

17. A method according to claim 15, wherein receiving information indicating that the transaction request is, at least in part, declined includes receiving this information from the customer terminal.

18. A method according to claim 17, wherein receiving this information from the customer terminal is in response to a customer at the customer terminal requesting review of the transaction request.

19. A method according to claim 15, wherein the method is implemented on a portable computer operated by an authorized person, and the method further comprises: receiving additional information about the transaction from the authorized person; and storing this additional information with the transaction.

20. A method according to claim 19, wherein the method further comprises notifying the authorization host that the declined transaction has been approved.

21. A computer-readable medium containing program instructions for overriding a rule-driven decision, wherein execution of the program instructions by one or more processors performs the steps of:
receiving a transaction request to perform a selected transaction from a consumer device;
authorizing or rejecting the transaction request based on at least one rule; and
receiving an override request sent from the consumer device when the transaction request was rejected, and
when override conditions are met, re-authorizing the transaction request that was previously rejected based at least in part on the override request sent from the consumer device.
